(19) United States
(12) Patent Application Publication
(10) Pub. No.: US 2022/0299374 A1
(43) Pub. Date: Sep. 22, 2022

(54) METHOD AND SYSTEM FOR ACQUIRING THREE-DOMAIN INFORMATION OF ULTRAFAST LIGHT FIELD

(71) Applicant: SOUTH CHINA UNIVERSITY OF TECHNOLOGY, Guangzhou (CN)

(72) Inventors: Zhongmin YANG, Guangzhou (CN); Wei LIN, Guangzhou (CN); Chao MENG, Guangzhou (CN); Xiaoxiao WEN, Guangzhou (CN); Tian QIAO, Guangzhou (CN)

(73) Assignee: SOUTH CHINA UNIVERSITY OF TECHNOLOGY, Guangzhou (CN)

(21) Appl. No.: 16/964,095

(22) PCT Filed: Jun. 21, 2019
(86) PCT No.: PCT/CN2019/092424

§ 371 Date: Jul. 22, 2020

(30) Foreign Application Priority Data
May 17, 2019 (CN) 201910412688.7

(51) Int. Cl. G01J 11/00; G01J 9/04

(52) U.S. Cl. CPC G01J 11/00; G01J 9/04

(57) ABSTRACT

Disclosed are a method and a system for acquiring three-domain information of ultrafast light field. The method includes: acquiring time-domain information at positions of respective spatial points in a first signal to be measured; acquiring first frequency-domain information of continuous light portions at positions of respective spatial points in a second signal to be measured; acquiring second frequency-domain information of pulse light portions at positions of respective spatial points in a third signal to be measured; and fusing the time-domain information, the first frequency-domain information, and the second frequency-domain information, and determining three-domain information of an ultrafast light field signal according to information obtained by the fusion; wherein, the first signal to be measured, the second signal to be measured and the third signal to be measured are three signals obtained by splitting the ultrafast light field signal to be measured.

### FIELD

The present application relates to the field of ultrafast signal measurement technology, in particular to a method and a system for acquiring three-domain information of ultrafast light field.

### BACKGROUND

Due to the wide application of ultrashort pulses in research fields such as femtosecond chemistry, attosecond science, and free electron lasers, etc., the development of ultrafast light field (time amount of picosecond or femtosecond) measurement technology has great significance. Early research on ultrafast measurement technology generally focused on only one aspect of time, space, and frequency. With the deepening research on aspects such as vortex optical communication, spatial-temporal soliton pulses, multimode mode-locked lasers, and high-dimensional transient laser dynamic process, etc., the realization of real-time measurement of the ultrafast light field in space-time-frequency three-domain has become the ultimate goal of development in this field. However, the measurement results obtained by the conventional solutions are one-sided, and it is difficult to perform comprehensive real-time measurement of the space-time-frequency three-domain information of the ultrafast light field.

### SUMMARY

Based on this, for addressing the above technical problems, it is necessary to provide a method and a system for acquiring three-domain information of ultrafast light field, which can obtain space-time-frequency three-domain information of the ultrafast light field in real time.

A method for acquiring three-domain information of ultrafast light field includes: acquiring time-domain information at positions of respective spatial points in a first signal to be measured; acquiring first frequency-domain information of continuous light portions at positions of respective spatial points in a second signal to be measured; acquiring second frequency-domain information of pulse light portions at positions of respective spatial points in a third signal to be measured; and fusing the time-domain information, the first frequency-domain information, and the second frequency-domain information, and determining three-domain information of an ultrafast light field signal according to information obtained by the fusion; wherein, the first signal to be measured, the second signal to be measured and the third signal to be measured are three signals obtained by splitting the ultrafast light field signal to be measured.

In the above method for acquiring three-domain information of ultrafast light field, by acquiring the time-domain information at the positions of the respective spatial points in the first signal to be measured, acquiring the first frequency-domain information of the continuous light portions at the positions of the respective spatial points in the second signal to be measured, acquiring the second frequency-domain information of the pulse light portions at the positions of the respective spatial points in the third signal to be measured, and fusing the time-domain information, the first frequency-domain information, and the second frequency-domain information, and determining the three-domain information of the ultrafast light field signal according to the information obtained by the fusion, real-time measurement of the space-time-frequency three-domain information of the ultrafast light field signal is realized, and this method has high integrity and timeliness.

A system for acquiring three-domain information of ultrafast light field includes: a space-time synchronous amplification module, a first spectral spectroscopic component, a first multi-channel high-speed photoelectric conversion component, a time lens time-frequency transformation optical path, a second multi-channel high-speed photoelectric conversion component, a time-domain stretching dispersion component, a second spectral spectroscopic component, a third multi-channel high-speed photoelectric conversion component, and a fusion terminal; the space-time synchronous amplification module performs time-domain amplification on the first signal to be measured to obtain a time-domain amplified signal; the first spectral spectroscopic component performs spectral spectroscopy at positions of respective spatial points of the time-domain amplified signal; the first multi-channel high-speed photoelectric conversion component converts a plurality of signals obtained after the spectral spectroscopy into electrical signals to obtain time-domain information at the positions of the respective spatial points; the first signal to be measured, the second signal to be measured and the third signal to be measured are three signals obtained by splitting a ultrafast light field signal to be measured; the time lens time-frequency transformation optical path performs time lens time-frequency transformation processing on the second signal to be measured; the second multi-channel high-speed photoelectric conversion component converts optical signals at positions of respective spatial points in a signal obtained after the time lens time-frequency transformation processing into electrical signals to obtain first frequency-domain information; the time-domain stretching dispersion component performs time-domain stretching on the third signal to be measured to realize Fourier transformation to obtain a time-frequency transformed spectrum; the second spectral spectroscopic component performs spectral spectroscopy on the time-frequency transformed spectrum to obtain decoupled time-domain overlapping information; the third multi-channel high-speed photoelectric conversion component performs photoelectric conversion on the decoupled time-domain overlapping information to obtain second frequency-domain information; and the fusion terminal fuses the time-domain information, the first frequency-domain information and the second frequency-domain information to determine three-domain information of the ultrafast light field signal.

In the above system for acquiring three-domain information of ultrafast light field, the time-domain information at the positions of the respective spatial points can be acquired for the first signal to be measured, the first frequency-domain information of the continuous light portions at the positions of the respective spatial points can be acquired for the second signal to be measured, and the second frequency-domain information of the pulse light portions at the positions of the respective spatial points can be acquired for the third signal to be measured. Thus, it is possible to measure the space-time-frequency three-domain information of the corresponding ultrafast light field signal in real time, and to make the process of acquiring the space-time-frequency three-domain information of the ultrafast light field signal to have higher timeliness and integrity.

### BRIEF DESCRIPTION OF THE DRAWINGS

FIG. 1 is a schematic flowchart of a method for acquiring three-domain information of ultrafast light field in an embodiment.

FIG. 2 is a schematic diagram of a signal to be measured of an embodiment.

FIG. 3 is a schematic diagram of results of simulation test for acquiring time-domain information of ultrafast light field in an embodiment.

FIG. 4 is a schematic diagram of results of simulation test for acquiring frequency-domain information of ultrafast light field in an embodiment.

FIG. 5 is a schematic diagram of results of simulation test for measuring three-domain information of the present application in an embodiment.

FIG. 6 is a structural block diagram of a system for acquiring three-domain information of ultrafast light field in an embodiment.

FIG. 7 is a structural block diagram of a system for acquiring three-domain information of ultrafast light field in another embodiment.

### DETAILED DESCRIPTION OF THE EMBODIMENTS

Reference will be made to the accompanying drawings and embodiments to describe the present application in detail, so that the objects, technical solutions and advantages of the present application can be more apparent and understandable. It should be understood that the specific embodiments described herein are only used to explain the present application and not intended to limit the present application.

Reference herein to “embodiment” means that specific features, structures, or characteristics described with reference to the embodiments may be included in at least one embodiment of the present application. A phrase appeared in various places in the specification does not necessarily refer to one same embodiment, nor does it refer to an independent or alternative embodiment mutually exclusive of other embodiments. Those skilled in the art can understand explicitly and implicitly that the embodiments described herein can be combined with other embodiments.

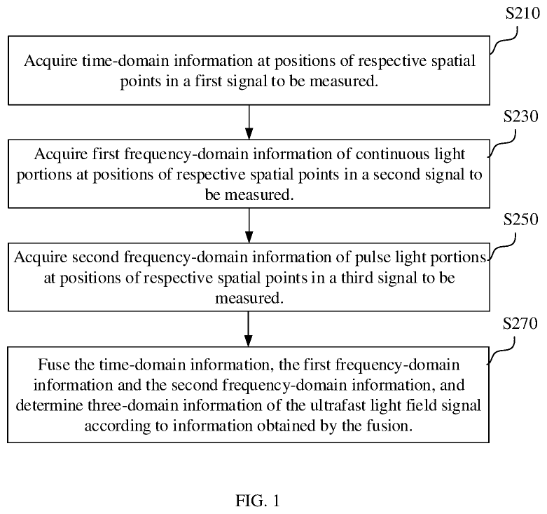

In an embodiment, as shown in FIG. 1, a method for acquiring three-domain information of ultrafast light field is provided. The method includes the following steps.

At S210, time-domain information at positions of respective spatial points in a first signal to be measured is acquired.

An ultrafast light field signal often has spatial complexity, and can be split into three signals using an optical splitter: a first signal to be measured, a second signal to be measured, and a third signal to be measured. It is also possible to beam combine the above ultrafast light field signal with a relevant synchronous reference pulse signal, and split the combined signal into three signals: a first signal to be measured, a second signal to be measured and a third signal to be measured, such that the above three signals each include a synchronous reference pulse signal to ensure that a subsequent fusion process is based on the synchronous reference pulse signal, thereby improving the accuracy of the fusion.

The above first signal to be measured can also be beam combined with a single-frequency laser signal to acquire the time-domain information at the positions of the respective spatial points, so that reconstruction of time-domain phase information of the first signal to be measured is realized during acquiring the time-domain information.

At S230, first frequency-domain information of continuous light portions at positions of respective spatial points in a second signal to be measured is acquired.

In the above step, the second signal can pass through a high refresh rate time lens time-frequency transformation optical path, and then the optical signals at the respective points in space can be converted into electrical signals, thereby obtaining the second frequency-domain information of the continuous light portions of the ultrafast light field signal to be measured at the respective spatial points.

At S250, second frequency-domain information of pulse light portions at positions of respective spatial points in a third signal to be measured is acquired. The first signal to be measured, the second signal to be measured and the third signal to be measured are three signals obtained by splitting the ultrafast light field signal to be measured.

In the above step, the third signal to be measured can be Fourier transformed to obtain a spatially resolved time-frequency transformed spectrum, and then spectroscopy is performed on a light field signal at a position of each of the spatial points, and then a plurality of optical signals obtained after the spectroscopy at each of the spatial points are converted into electrical signals, so as to obtain the second frequency-domain information of the pulse light portions of the ultrafast optical field signal to be measured at the respective spatial points.

At S270, the time-domain information, the first frequency-domain information and the second frequency-domain information are fused, and three-domain information of the ultrafast light field signal is determined according to information obtained by the fusion.

In the above step, alignment and fusion can be performed on the time-domain information, the first-frequency domain information and the second frequency-domain information to ensure the quality of the fusion. Before the fusion of the time-domain information, the first frequency-domain information and the second-frequency domain information, the time-domain information, the first frequency-domain information and the second frequency-domain information can be analog-to-digital converted to obtain the corresponding digital information, so as to facilitate the back-end digital processing, and to ensure the accuracy of the processing processes such as the fusion.

In the above method for acquiring three-domain information of ultrafast light field, by acquiring the time-domain information at the positions of the respective spatial points in the first signal to be measured, acquiring the first frequency-domain information of the continuous light portions at the positions of the respective spatial points in the second signal to be measured, acquiring the second frequency-domain information of the pulse light portions at the positions of the respective spatial points in the third signal to be measured, fusing the time-domain information, the first frequency-domain information, and the second frequency-domain information, and determining the three-domain information of the ultrafast light field signal according to the information obtained by the fusion, it is possible to realize real-time measurement for the space-time-frequency three-domain information of the ultrafast light field signal with high integrity and timeliness.

In an embodiment, before the above acquiring time-domain information at the positions of the respective spatial points in the first signal to be measured, the above method further includes: performing optical splitting processing after beam combining the ultrafast light field signal and a synchronous reference pulse signal, to obtain the first signal to be measured, the second signal to be measured, and the third signal to be measured.

After acquiring the second frequency-domain information of the pulse light portions at the positions of the respective spatial points in the third signal to be measured, the above method further includes: aligning any two of the time-domain information, the first frequency-domain information, and the second frequency-domain information with a third one thereof respectively according to synchronous reference pulse signals respectively included in the time-domain information, the first frequency-domain information, and the second frequency-domain information; and fusing the time-domain information, the first frequency-domain information, and the second frequency-domain information after the time-domain information, the first frequency-domain information, and the second frequency-domain information are aligned.

The above synchronization reference pulse signals may each carry an alignment mark, and any two of the time-domain information, the first frequency-domain information, and the second frequency-domain information can be aligned with the third one respectively, to achieve alignment among the time-domain information, the first frequency-domain information, and the second frequency-domain information. The three-domain information determined after the fusion of the above time-domain information, first frequency-domain information, and second frequency-domain information includes the three-domain information of time domain, space domain, and frequency domain of the ultrafast light field signal, and has high integrity.

As an embodiment, the time axes of the respective collected signals can be corrected based on the synchronous reference pulse signals to obtain the space-time-frequency three-domain information under a unified time axis. The phase information of the light field is inverted based on a generalized projection method; and upon assuming an initial phase, the phase information of the ultrafast light field is reconstructed by the following iteration relationship:

$${u}_{t 1} ( x , y , t ) = \sqrt{{I}_{M} ( x , y , t )} {e}^{i {ϕ}_{0} ( x , y , t )} ,$$

$${u}_{ω 0} ( x , y , ω ) = ℱ [ {u}_{t 1} ( x , y , t ) ] ,$$

$${u}_{ω 1} ( x , y , ω ) = \frac{\sqrt{{\tilde{I}}_{M} ( x , y , ω )}}{\int \sqrt{{\tilde{I}}_{M} ( x , y , ω )} d ω} \frac{{u}_{ω 0}}{\vert {u}_{ω 0} \vert} \int \vert {u}_{ω 0} \vert d ω ,$$

$${u}_{t 0} ( x , y , t ) = {ℱ}^{- 1} [ {u}_{ω 1} ( x , y , ω ) ] .$$

Based on measurement samples I_{M}(x, y, t) and I_{M}(x, y, ω) in time domain and in frequency domain, the method of the inversion is mainly divided into four iterative steps. At Step 1, obtain a time-domain light field expression uₜ₁(x, y, t) in the first iteration by using the time-domain measurement sample and a phase expression ϕ₀(x, y, t); under an initial condition, ϕ₀(x, y, t) takes a random phase, otherwise, ϕ₀ (x, y, t) takes the phase of the light field expression uₜ₀(x, y, t) in the fourth iteration. At Step 2, perform. Fourier transformation on the light field expression uₜ₁(x, y, t) in the first iteration to obtain the frequency-domain light field expression u_{ω0}(x, y, ω) in the second iteration. At Step 3, obtain the frequency-domain light field expression u_{ω1}(x, y, ω) in the third iteration by using the frequency-domain measurement sample and the frequency-domain light field expression u_{ω0}(x, y, ω) in the second iteration. And at Step 4, perform inverse Fourier transformation on the frequency-domain light field expression u_{ω1} (x, y, ω) in the third iteration to obtain the frequency-domain light field expression uₜ₀(x, y, t) in the fourth iteration. Through repeatedly cycling this process, real-time ultrafast measurement of space-time-frequency three-domain information of the ultrafast light field is finally achieved.

In an embodiment, the above acquiring time-domain information at positions of respective spatial points in a first signal to be measured includes: performing time-domain amplification on the first signal to be measured to obtain a time-domain amplified signal; performing spectral spectroscopy at positions of respective spatial points of the time-domain amplified signal; and converting a plurality of signals obtained after the spectral spectroscopy into electrical signals to obtain the time-domain information at the positions of the respective spatial points.

Specifically, the above first signal to be measured can be beam combined with a single-frequency laser signal and then be input into a space-time synchronous amplification module to perform M-times time-domain amplification to obtain a time-domain amplified signal, so as to ensure the accuracy of the time-domain information at the positions of the respective spatial points subsequently obtained according to the above time-domain amplified signal.

As an embodiment, the above perform time-domain amplification on the first signal to be measured to obtain a time-domain amplified signal includes: perform first dispersion processing on the first signal to be measured, apply first periodic secondary phase modulation in time domain to a light field signal obtained after the first dispersion processing, and perform second dispersion processing on the light field signal obtained after the modulation to obtain the time-domain amplified signal.

The above first signal to be measured can be directly input or be beam combined with a single-frequency laser signal and then subjected to first dispersion processing corresponding to dispersion Dᵢₙ. A dispersion parameter Dᵢₙ (that is, a first dispersion amount) used in the first dispersion processing can be referred to as an “object distance” of the space-time synchronous amplification module. Then, periodic secondary phase modulation

$${Φ}_{T} ( t ) = - \frac{{it}^{2}}{2 {D}_{f}}$$

in time domain is applied to the light field signal; during this periodic secondary phase modulation, the frequency is f and the width of the modulation window is T_{f} to realize the function of the time lens. The modulation parameter D_{f} used during the first periodic secondary phase modulation can also be called as a “focal distance” of the time lens, or a dispersion amount of the pump end of the space-time synchronous amplification module. The phase modulated optical field signal is subjected to second dispersion processing corresponding to dispersion Dₒᵤₜ and then a time-domain signal is output, the dispersion parameter Dₒᵤₜ (that is, a second dispersion amount) used in the second dispersion processing may also be called as an “image distance” of the space-time synchronous amplification module. Specifically, the above method for loading time-domain secondary phase modulation (the process of the first periodic secondary phase modulation) is an electro-optical phase modulator, or the method is an optical parametric frequency conversion process based on a chirped pulse sequence.

Optionally, the amplification factor M of the space-time synchronous amplification module and the frequency f in the process of the first periodic secondary phase modulation, and the width T_{f} of the modulation window satisfy the following relationship:

$${T}_{f} \times M \geq \frac{1}{f} ,$$

so as to improve the time-domain amplification effect of the first signal to be measured.

As an embodiment, a dispersion parameter used in the first dispersion processing, a dispersion parameter used in the second dispersion processing, and a modulation parameter used in the process of the first periodic secondary phase modulation satisfy the following relationship:

$$\frac{1}{{D}_{in}} + \frac{1}{{D}_{out}} = \frac{1}{{D}_{f}} .$$

In the expression, Dᵢₙ represents the dispersion parameter used in the first dispersion processing, Dₒᵤₜ, represents the dispersion parameter used in the second dispersion processing, and D_{f} represents the modulation parameter used in the process of the first periodic secondary phase modulation.

A time-domain magnification M of the first signal to be measured is:

$$M = \vert \frac{{D}_{out}}{{D}_{in}} \vert .$$

In the embodiment, it is possible to improve the accuracy of the obtained time-domain amplified signal, thereby improving the accuracy of the obtained time-domain information.

In an example, the above first signal to be measured may be directly input, or be beam combined with a single-frequency laser signal and then input into a space-time synchronous amplification module for time-domain amplification. The expression of the input light field Aᵢₙ(x, y, t) in the process of the time-domain amplification is:

Aᵢₙ(x, y, t)=eᵣ(x, y)+eₛ(x, y, t)exp[iφₛ(x, y, t)+iΔkx].

In this expression, in case that the first signal to be measured is beam combined with the single-frequency laser signal, eᵣ(x, y) represents an optical field amplitude of the single-frequency laser signal, eₛ(x, y, t) represents an optical field amplitude of the first signal to be measured, φₛ(x, y, t) represents a phase of the first signal to be measured, Δk represents a difference between the propagation constants of the ultrafast light field and the single-frequency laser signal, Aᵢₙ(x, y, t) represents a signal obtained after the first signal to be measured is beam combined with the single-frequency laser signal, i represents an imaginary unit, t represents a time variable, and x and y respectively represent a horizontal coordinate and a vertical coordinate in space. Based on a space-time correspondence principle, input-end dispersion (first dispersion), pump-end dispersion, and output-end dispersion (second dispersion) in the space-time synchronous amplification module can be M-times magnified in time-domain under a condition of satisfying an imaging relationship. The light field Aₒᵤₜ(x, y, t) output by the space-time synchronous amplification module is shown in the following expression:

$${A}_{out} ( x , y , t ) = {ℱ}^{- 1} ( ℱ \begin{matrix}\{ \begin{matrix}{ℱ}^{- 1} [ {A}_{in} ( x , y , ω ) {\underbrace{exp ( {iD}_{in} {ω}^{2} / 2 )}}_{input end dispersion} ] \\ {\underbrace{ℱ [ exp ( {iD}_{f} {ω}^{2} / 2 ) ]}}_{pump end dispersion}\end{matrix} \} \\ {\underbrace{exp ( {iD}_{out} {ω}^{2} / 2 )}}_{output end dispersion}\end{matrix} ) ∝ exp ( - i \frac{{t}^{2}}{2 {D}_{out} + {D}_{f}} ) {A}_{in} ( x , y , \frac{{D}_{f} t / 2}{{D}_{out} + {D}_{f} / 2} ) ∝ {A}_{in} ( x , y , \frac{t}{M} ) .$$

Aᵢₙ(x, y, ω) represents an expression in time domain of a signal obtained after the first signal to be measured and the single-frequency laser signal are beam combined, Aᵢₙ(x, y, ω) represents an expression in frequency domain of a signal obtained after the first signal to be measured and the single-frequency laser signal are beam combined, Aₒᵤₜ(x,y,t) represents the output signal obtained after the amplification in the time domain, Dᵢₙ and Dₒᵤₜ respectively represent a value of the dispersion amount of the input end and a dispersion amount of the output end of the space-time synchronous amplification module, D_{f} represents the ⁻modulation parameter used in the process of the first periodic secondary phase modulation, M is the amplification factor, and the symbol “ [symbol] ” represents Fourier transformation, the symbol “ [symbol] ⁻¹” represents inverse Fourier transformation, i represents imaginary unit, t represents a time variable, and ω represents a frequency variable. The input ultrafast light field signal (the first signal to be measured) is amplified in time domain. Meanwhile, the input ultrafast light field signal can be deduced backwards by using the Fourier domain filtering method from the coherent light field signal beam combined with the single-frequency laser signal after having being amplified in time domain. Since a long time scale light field signal will overlap after undergoing time-domain amplification, it is proposed herein to use a spectral spectroscopy method to decouple the time-domain overlapping signal at the output end. A decoupled intensity signal A(x, y, τ; ω₀) obtained by passing the light field signal having passed through the space-time synchronous amplification module through a first spectral spectroscopic component is shown as in the following expression:

$$A ( x , y , t ; {ω}_{0} ) = {ℱ}^{- 1} [ ℱ [ {A}_{out} ( x , y , t ) ] {\underbrace{H ( ω - {ω}_{0} )}}_{frequency respomse} ] ∝ {A}_{in} ( x , y , - {ω}_{0} {D}_{f} / 2 ) .$$

H(ω−ω₀) is a spectrum response function, ω₀ is a center frequency, and the symbol “∝” represents being proportional to, Aₒᵤₜ(x, y, t) represents the output signal after having being time-domain amplified, and A(x, y, t; ω₀) represents the output signal obtained after passing the time-domain amplified signal through the first spectral spectroscopic component. The spectral spectroscopic components can act on the respective spatial positions, and then a multi-channel high-speed photoelectric conversion component is provided after each of the spectral spectroscopic components to convert the output signals into electrical signals, and the electrical signals are collected and recorded to obtain the time-domain information at the positions of the respective spatial points in the first signal to be measured.

In an embodiment, the above acquire first frequency-domain information of continuous light portions at positions of respective spatial points in a second signal to be measured includes: perform time lens time-frequency transformation processing on the second signal to be measured, and convert an optical signal at positions of respective spatial points in a signal obtained after the time lens time-frequency transformation processing into an electrical signal to obtain the first frequency-domain information.

The above time lens time-frequency transformation processing may be performed by performing corresponding processing on the second signal to be measured with a high refresh rate time lens time-frequency transformation optical path. The above first frequency-domain information can accurately characterize the continuous light portion of the ultrafast light field signal at each of the spatial points.

In this embodiment, the second signal to be measured is input into the high refresh rate time lens time-frequency transformation optical path, such that real-time measurement of the high refresh rate continuous light component frequency-domain information of the ultrafast light field signal is achieved, and complete measurement of ultra-high refresh rate and high resolution frequency-domain intensity information of the ultra-fast light field can also be achieved.

As an embodiment, the above performing the time lens time-frequency transformation processing on the second signal to be measured, and converting the optical signal at the positions of the respective spatial points in the signal obtained after the time lens time-frequency transformation processing into an electrical signal to obtain the first frequency-domain information includes: performing third dispersion processing on the second signal to be measured to obtain a first dispersion signal; applying second periodic secondary phase modulation in time domain to the first dispersion signal to achieve time lens processing to obtain a modulated signal; performing fourth dispersion processing on the modulated signal to obtain initial frequency-domain information; and performing photoelectric conversion on the initial frequency-domain information at the positions of the respective spatial points to obtain the second frequency-domain information.

Specifically, the above process of performing the time lens time-frequency transformation processing on the second signal to be measured, and converting the optical signal at the positions of the respective spatial points in the signal obtained after the time lens time--frequency transformation processing into an electrical signal to obtain the first frequency-domain information may also be as follows: passing the second signal to be measured through a third dispersion component to perform dispersion processing with a dispersion amount of Φᵢₙ on the second signal to be measured, to obtain a first dispersion signal; the dispersion amount of the above third dispersion component is Φᵢₙ, which can also be called as an “object distance” of the high refresh rate time lens time-frequency transformation optical path; apply periodic secondary phase modulation

$$Φ ( t ) = - \frac{- {it}^{2}}{2 {Φ}_{f}}$$

in time domain to the first dispersion signal to achieve e function of a time lens to obtain a modulated signal; t represents a time variable, i represents an imaginary unit, and Φ_{f} represents a modulation parameter used in the process of the periodic secondary phase modulation, Φ(t) represents a periodic secondary phase modulation, and the above modulation parameter Φ_{f} can also be called as a “focal distance” of the time lens; passing the light field signal carrying the periodic time-domain secondary phase modulation (i.e., the modulated signal) through the fourth dispersion component to perform dispersion processing with a dispersion amount of Φₒᵤₜ on the light field signal carrying the periodic time-domain secondary phase modulation, to obtain an initial frequency-domain information; the fourth dispersion amount Φₒᵤₜ is also called as an “image distance” of the high refresh rate time lens time-frequency transformation optical path; specifically, the above method of loading the time-domain secondary phase modulation (the process of the second periodic secondary phase modulation) may be performed by an electro-optical phase modulator or an optical parametric frequency conversion process of a chirped pulse sequence; and converting the light field signal at each position in the space into an electrical signal, to obtain the second frequency-domain information.

As an embodiment, a third dispersion amount Φᵢₙ and the fourth dispersion amount Φₒᵤₜ are respectively equal to a modulation parameter Φ_{f} used in the process of the second periodic secondary phase modulation, that is, Φᵢₙ=Φₒᵤₜ=Φ_{f}. The third dispersion amount is a dispersion parameter used in the third dispersion processing, and the fourth dispersion magnitude is a dispersion parameter used in the fourth dispersion processing.

In an example, the second signal to be measured enters the high refresh rate time lens time-frequency transformation optical path, and the process of the frequency domain measurement of the continuous light components of the ultrafast light field can be compared to the Fourier transform process in the spatial lens 2-f system. The image E_{TL}(x, y, t) of the continuous light components in the light field after the time lens can be expressed as:

$${E}_{TL} ( x , y , t ) ∝ \{ rect ( \frac{t}{T} ) {A}_{cw} ( x , y , t ) exp [ i ( 2 {ω}_{p} - {ω}_{s} ) t ] {\underbrace{exp ( \frac{- {it}^{2}}{2 {Φ}_{f}} )}}_{second phase modulation} \} .$$

In the expression, the rectangular function

$$rect ( \frac{t}{T} )$$

describes the time-domain pulse as an equivalent lens, ωₚ represents a pump frequency, ωₛ represents a signal light frequency, Φ_{f} represents a modulation parameter used in the process of the second periodic secondary phase modulation in the time lens optical path, the symbol “∝<” represents being proportional to, i represents an imaginary unit, A_{cw}(x, y, t) represents an expression of light field of the continuous light portions, E_{TL}(x, y, t) represents an image of the continuous light portion after the time lens, and t represents a time variable. After the fourth dispersion, the time-frequency Fourier transform is realized on the image surface, and the expression of the output light field E_{TLS}(x, y, t) is shown as follows:

$${E}_{TLS} ( x , y , t ) ∝ {ℱ}^{- 1} \{ ℱ [ {E}_{TL} ( x , y , t ) ] exp ( i {Φ}_{out} {ω}^{2} / 2 ) \} ∝ {\int }_{- ∞}^{+ ∞} \{ rect ( \frac{τ}{T} ) exp ( \frac{- {it}^{2}}{2 {Φ}_{f}} ) {A}_{cw} ( x , y , τ ) exp [ i ( 2 {ω}_{p} - {ω}_{s} ( x , y ) τ ) ] {\underbrace{exp [ - \frac{- {i ( t - τ )}^{2}}{2 {Φ}_{out}} )}}_{\begin{matrix}output dispersion , \\ image surface\end{matrix}} \} d τ ∝ exp ( \frac{- {it}^{2}}{2 {Φ}_{out}} ) sin c [ T ( δ ω ( x , y ) + \frac{t}{{Φ}_{out}} ) ] .$$

E_{TLS}(x, y, t) represents the expression of the light field output through the high refresh rate time lens optical path, Φₒᵤₜ represents the value of the dispersion amount at the output end (the dispersion amount of the fourth dispersion) in the time lens frequency-frequency transformation optical path, the symbol “ [symbol] ” represents the Fourier transformation, the symbol “ [symbol] ⁻¹” represents the inverse Fourier transformation, δω=2ωₚ−ωₛ, the variable δω of the function sinc carries information of the continuous light frequency ωₛ, and under the condition of 2ΦₒᵤₜΔΩₚ<T_{R} in which ΔΩₚ represents the spectral bandwidth of the pump pulse in the time lens time-frequency transformation optical path and T_{R} represents the pulse interval time of the pump pulse, there will be no problem of overlapping of time-domain signal in the time stretching time-frequency transformation optical path. After the ultrafast light field has passed through the high refresh rate time lens time-frequency transformation optical path, a high-speed photoelectric conversion component is provided at each of the spatial positions of the output signal to realize the collection and recording of the frequency-domain information of the continuous light portions of the signal, to obtain the first frequency-domain information.

In an embodiment, the above acquiring the second frequency-domain information of the pulse optical portions at the positions of respective spatial points in the third signal to be measured includes: performing dispersion and then performing Fourier transformation on the third signal to be measured to obtain a time-frequency transformed spectrum; performing spectroscopy processing respectively on the light field signals at positions of respective spatial points in the time-frequency transformed spectrum to obtain a plurality of optical signals; and performing photoelectric conversion respectively on the respective optical signals to obtain the second frequency-domain information.

In this embodiment, the third signal to be measured can be fully stretched and widened in time domain through the dispersion Φ_{TS} to achieve time-frequency Fourier transformation to obtain a spatially resolved time-frequency transformed spectrum, and then spectroscopy is performed on a light field signal at a position of each of the spatial points by passing through the spectral spectroscopic component, and then a plurality of optical signals obtained after the spectral spectroscopy at each of the spatial points are converted into electrical signals, to obtain the second frequency-domain information of the pulse light portions of the ultrafast optical field signal to be measured at the respective spatial points, so as to ensure the accuracy of the obtained second frequency-domain information.

Specifically, the third signal to be measured may enter the time-domain stretching dispersion component, and after having being time stretched, the ultrafast light field to be measured (the third signal to be measured) achieves time-frequency Fourier transformation. Based on the principle of space-time correspondence, the strength I_{TSS}(x, y, t) of the output signal under the approximate condition of Fraunhofer diffraction can be expressed as:

$${I}_{TSS} ( x , y , t ) = {\vert \int {A}_{p} ( x , y , ω ) {e}^{- i {Φ}_{TS} {ω}^{2} / 2} {e}^{i ω t} d ω \vert}^{2} = \vert \int {A}_{p} ( x , y , ω ) {e}^{( - i {Φ}_{TS} / 2 ) {( ω - t / {Φ}_{TS} )}^{2}} d ω {\vert}^{2} {\to }^{Fraunhofer approximation} {\vert {A}_{p} ( x , y , \frac{t}{{Φ}_{TS}} ) \vert}^{2} .$$

Aₚ(x, y, ω) represents an expression in frequency domain of the light field of the pulse light portions of the third signal to be measured, Φ_{TS} represents a value of the dispersion amount of the time-domain stretching dispersion component, i represents an imaginary unit, t represents a time variable, and ω represents a frequency variable.

In the frequency-domain measurement with high spectral resolution, a problem of overlapping in time-domain signal will occur after the time stretching time-frequency transformation. To solve the above problem, a spectral spectroscopy method can be used to decouple the time-domain overlapping signal at the output end. A decoupled intensity signal obtained by passing the time-domain light field output by the time-domain stretching dispersion component through a second spectral spectroscopic component is shown as in the following expression:

$${I}_{TSS} ( x , y , t ) = {\vert \int {A}_{p} ( x , y , ω ) {\underbrace{H ( ω - {ω}_{0} )}}_{spectrum response} {e}^{- i {Φ}_{TS} {ω}^{2} / 2} {e}^{i ω t} d ω \vert}^{2} {\to }^{approximate integration} {\vert {A}_{p} ( x , y , \frac{t}{{Φ}_{TS}} ) H ( \frac{t}{{Φ}_{TS}} - {ω}_{0} ) \vert}^{2} .$$

H(ω−ω₀) is a spectrum response function, and is a center frequency. It can be seen from the above expression that the time variable t and the frequency variable ω have a one-to-one correspondence relationship. The light field signal obtained after the time-domain stretching time-frequency transformation interacts with the spectral spectroscopic component and is then directly mapped to the time-domain signal at the time t=ω₀Φ_{TS}. The spectral spectroscopic components perform spectral spectroscopy operation on each of the respective points in the space, and then a multi-channel high-speed photoelectric conversion component is provided after each of the spectral spectroscopic components to photoelectrically convert and collect the output signal to obtain the second frequency-domain information.

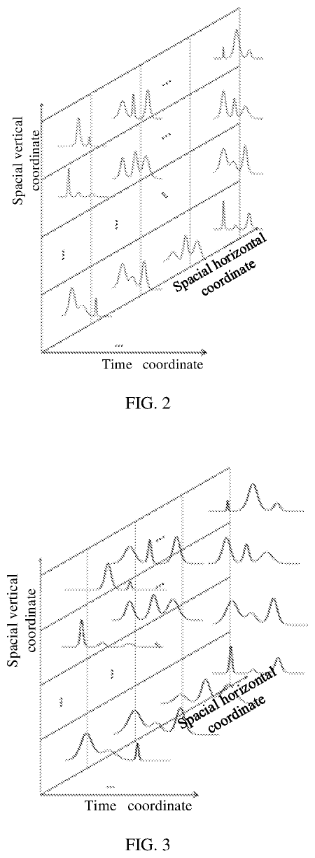

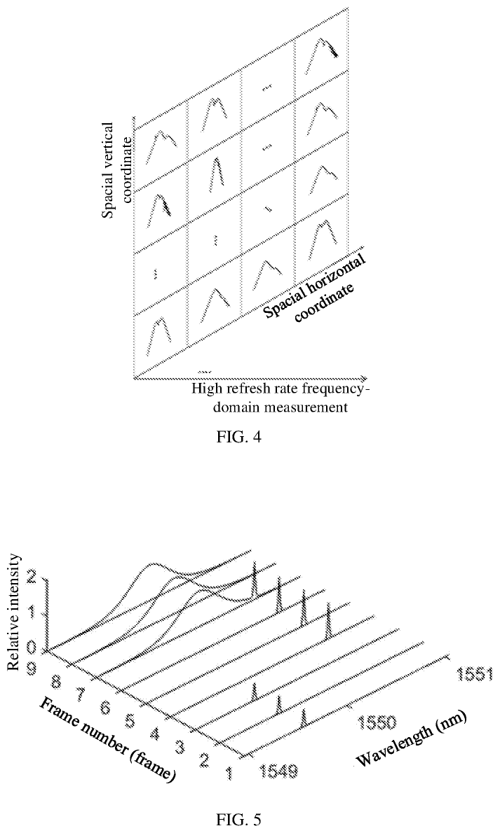

In an embodiment, a three-domain signal acquisition simulation is performed on the ultrafast light field signal with spatial complexity. The signal to be measured with spatial complexity is shown in FIG. 2. The light fields at different spatial positions are different in time domain. The simulation test results in time domain and in frequency domain for the signal to be measured obtained through the method for acquiring three-domain information of the ultrafast light field provided by the present application are shown in FIG. 3 and FIG. 4, respectively. From these figures it can be seen that, the time-domain and frequency-domain information of the ultrafast light field at different spatial positions can be obtained by the method for acquiring three-domain information of the ultrafast light field of the present application.

In a specific example, a signal to be measured with a time length of 9 ns at a single spatial position is measured by the method for acquiring three-domain information of the ultrafast light field of the present application. The simulation result obtained after passing through the measurement system of the present application is shown in FIG. 5. It can be seen from this figure that the method for acquiring three-domain information of the ultrafast light field of the present application has the ability to distinguish the continuous light portions in the ultrafast light field, meanwhile, its measurement refresh rate reaches 1 GHz.

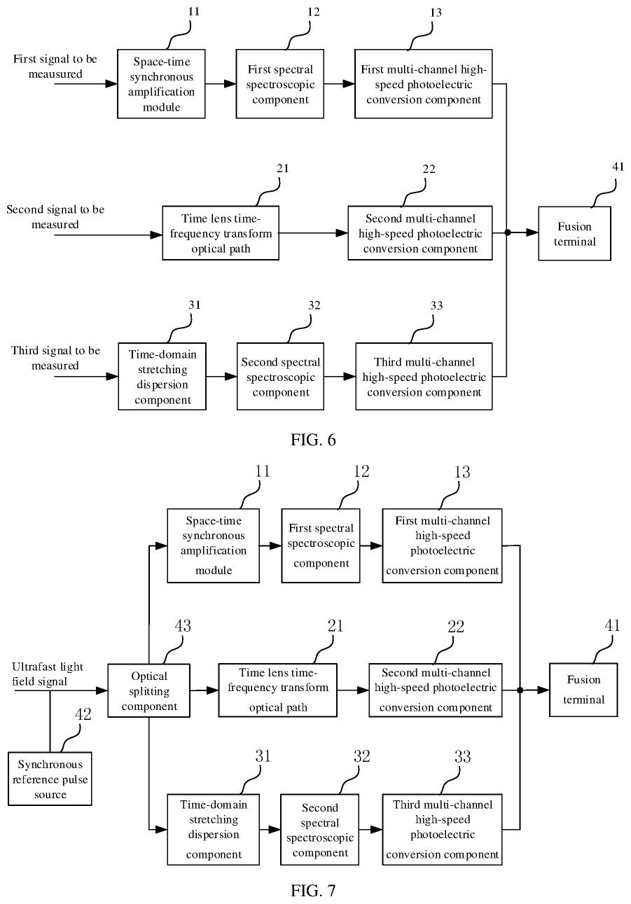

In an embodiment, as shown in FIG. 6, a system for acquiring three-domain information of ultrafast light field is provided, The system includes: a space-time synchronous amplification module 11, a first spectral spectroscopic component 12, a first multi-channel high-speed photoelectric conversion component 13, a time lens time-frequency transform optical path 21, a second multi-channel high-speed photoelectric conversion component 22, a time-domain stretching dispersion component 31, a second spectral spectroscopic component 32, a third multi-channel high-speed photoelectric conversion component 33, and a fusion terminal 41.

The space-time synchronous amplification module 11 performs time-domain amplification on the first signal to be measured to obtain a time-domain amplified signal; the first spectral spectroscopic component 12 performs spectral spectroscopy at positions of respective spatial points of the time-domain amplified signal; the first multi-channel high-speed photoelectric conversion component 13 converts a plurality of signals obtained after the spectral spectroscopy into electrical signals to obtain time-domain information at the positions of the respective spatial points; and the first signal to be measured, the second signal to be measured and the third signal to be measured are three signals obtained by splitting a ultrafast light field signal to be measured.

The time lens time-frequency transformation optical path 21 performs time lens time-frequency transformation processing on the second signal to be measured; the second multi-channel high-speed photoelectric conversion component 22 converts optical signals at positions of respective spatial points in a signal obtained after the time lens time-frequency transformation processing into electrical signals to obtain first frequency-domain information.

The time-domain stretching dispersion component 31 performs time-domain stretching on the third signal to be measured to realize Fourier transformation to obtain a time-frequency transformed spectrum; the second spectral spectroscopic component 32 performs spectral spectroscopy on the time-frequency transformed spectrum to obtain decoupled time-domain overlapping information; the third multi-channel high-speed photoelectric conversion component 33 performs photoelectric conversion on the decoupled time-domain overlapping information to obtain second frequency-domain information.

The fusion terminal 41 fuses the time-domain information, the first frequency-domain information and the second frequency-domain information to determine three-domain information of the ultrafast light field signal.

The above fusion terminal 41 is an intelligent terminal that has processing functions such as receiving various signals, and aligning and fusing corresponding signals. The above time lens time-frequency transformation optical path 21 is a high refresh rate time lens time-frequency transformation optical path, and can perform various processes that contribute to obtaining the frequency-domain information of the continuous light portions at the respective spatial points in the second beam combined signal, such as third dispersion processing, periodic time-phase modulation in time domain realizing time lens processing, and fourth dispersion processing, etc.

In the above system for acquiring three-domain information of ultrafast light field, the time-domain information at the positions of the respective spatial points can be acquired for the first signal to be measured, the first frequency-domain information of the continuous light portions at the positions of the respective spatial points can be acquired for the second signal to be measured, and the second frequency-domain information of the pulse light portions at the positions of the respective spatial points can be acquired for the third signal to be measured, so as to measure the space-time-frequency three-domain information of the corresponding ultrafast light field signal in real time, and to make the acquisition process of the space-time-frequency three-domain information of the ultrafast light field signal to have hither timeliness and integrity.

In an embodiment, referring to FIG. 7, the above system for acquiring three-domain information of ultrafast light field further includes a synchronous reference pulse source 42 and an optical splitting component 43.

The synchronous reference pulse source 42 generates a synchronous reference pulse signal; the optical splitting component 43 splits the beam-combined ultrafast light field signal and synchronous reference pulse signal into the first signal to be measured, the second signal to be measured and the third signal to be measured.

The fusion terminal 41 reads synchronous reference pulse signals contained in the time-domain information, the first frequency-domain information and the second frequency-domain information respectively, aligns any two of the time-domain information, the first frequency-domain information, and the second frequency-domain information with the third one thereof respectively, and fuses the time-domain information, the first frequency-domain information, and the second frequency-domain information after the same are aligned.

Specifically, the above synchronization reference pulse signals may each carry an alignment mark, and the fusion terminal 41 reads the alignment marks carried by time-domain information, the first frequency-domain information, and the second frequency-domain information respectively, and aligns any two of the time-domain information, the first frequency-domain information, and the second frequency-domain information with the third one thereof respectively, to improve the corresponding efficiency of the alignment.

In an embodiment, the time axes of the respective collected signals can be corrected based on the synchronous reference pulse signals to obtain a space-time-frequency three-domain information under a unified time axis. The phase information of the light field is inverted based on a generalized projection method; and upon assuming an initial phase, the phase information of the ultrafast light field is reconstructed by the following iteration relationship:

$${u}_{i 1} ( x , y , t ) = \sqrt{{I}_{M} ( x , y , t )} {e}^{i {ϕ}_{0} ( x , y , t )} , {u}_{ω 0} ( x , y , ω ) = ℱ [ {u}_{t 1} ( x , y , t ) ] , {u}_{ω 1} ( x , y , ω ) = \frac{\sqrt{{\overline{I}}_{M} ( x , y , ω )}}{\int \sqrt{{\overline{I}}_{M} ( x , y , ω )} d ω} \frac{{u}_{ω 0}}{\vert {u}_{ω 0} \vert} \int \vert {u}_{ω 0} \vert d ω , {u}_{t 0} ( x , y , t ) = {ℱ}^{- 1} [ {u}_{ω 1} ( x , y , ω ) ] .$$

Based on measurement samples I_{M}(x, y, t) and I_{M}(x, y, w) in time domain and in frequency domain, the method of the inversion is mainly divided into four iterative steps. Step 1, a time-domain light field expression uₜ₁(x, y, t) in the first iteration is obtained by using the time-domain measurement sample and a phase expression ϕ₀(x, y, t); under an initial condition, ϕ₀(x, y, t) takes a random phase, otherwise, ϕ₀ (x, y, t) takes the phase of the light field expression uₜ₀(x, y, t) in the fourth iteration. Step 2, Fourier transformation is performed on the light field expression uₜ₁(x, y, t) in the first iteration to obtain the frequency-domain light field expression u_{ω0}(x, y, ω) in the second iteration. Step 3, the frequency-domain light field expression u_{ω1}(x, y, ω) in the third iteration is obtained by using the frequency-domain measurement sample and the frequency-domain light field expression u_{ω0}(x, y, ω) in the second iteration. Step 4, inverse Fourier transformation is performed on the frequency-domain light field expression u_{ω1} (x, y, ω) in the third iteration to obtain the frequency-domain light field expression uₜ₀(x, y, t) in the fourth iteration. Through repeatedly cycling this process, real-time ultrafast measurement of space-time-frequency three-domain information of the ultrafast light field is finally achieved.

In an embodiment, the above space-time synchronous amplification module includes a first dispersion component, a first pump pulse light source, a first pump end dispersion component, a first highly nonlinear medium, a first optical filter and a second dispersion component.

The first dispersion component performs first dispersion processing on the first signal to be measured to form first detection light; the first pump pulse light source generates an ultrashort pulse sequence as a first pump pulse; the first pump end dispersion component applies dispersion to the first pump pulse to form a first pump light; the first highly nonlinear medium provides an nonlinear medium for an nonlinear parametric process between the first detection light and the first pump light; the first optical filter filters out first idle-frequency light generated in the nonlinear parametric process; and the second dispersion component performs second dispersion processing on the first idle-frequency light to obtain the time-domain amplified signal.

Optionally, the above first signal to be measured may further be beam combined with a single-frequency laser signal and then input into a first dispersion component of the space-time synchronous amplification module.

The above first signal to be measured can be directly input or be beam combined with a single-frequency laser signal and then pass through the first dispersion component to be performed with a dispersion Dᵢₙ to form the first detection light. A dispersion parameter Dᵢₙ used in the first dispersion processing can be called as an “object distance” of the space-time synchronous amplification module. The first pump end dispersion component applies a dispersion D_{f} to the first pump pulse to form the first pump light. The first pump light applies periodic secondary phase modulation

$${Φ}_{T} ( t ) = - \frac{{it}^{2}}{2 {D}_{f}}$$

in time domain to the light field signal; during this periodic secondary phase modulation, the frequency is f and the width of the modulation window is T_{f}, so as to realize the function of the time lens. The modulation parameter D_{f} used in the process of the first periodic secondary phase modulation can also be called as a “focal distance” of the time lens. The second dispersion component performs a dispersion Dₒᵤₜ on the first idle-frequency light, and a dispersion parameter Dₒᵤₜ used by the second dispersion component can also be called as an “image distance” of the space-time synchronous amplification module. Specifically, the above method for loading time-domain secondary phase modulation (the process of the first periodic secondary phase modulation) is an electro-optical phase modulator or an optical parametric frequency conversion process based on a chirped pulse sequence.

Optionally, the amplification factor M of the space-time synchronous amplification module, the frequency f in the process of the first periodic secondary phase modulation, and the width T_{f} of the modulation window satisfy the following relationship:

$${T}_{f} \times M \geq \frac{1}{f} ,$$

so as to improve the time-domain amplification effect of the first signal to be measured.

As an embodiment, the following relationship is satisfied between Dᵢₙ, Dₒᵤₜ, and

$${D}_{f} : \frac{1}{{D}_{i n}} + \frac{1}{{D}_{o u t}} = \frac{1}{{D}_{f}} .$$

A time-domain magnification M of the first signal to be measured is

$$M = \frac{{D}_{out}}{{D}_{i n}} .$$

In an example, the above first signal to be measured may be directly input, or be beam combined with a single-frequency laser signal and then input into a space-time synchronous amplification module for time-domain amplification.

The expression of the input light field Aᵢₙ(x, y, t) in the process of the time-domain amplification is:

Aᵢₙ(x, y, t)=eᵣ(x, y)+eₛ(x, y, t)exp[iφₛ(x, y, t)+iΔkx].

In this expression, in case that the first signal to be measured is beam combined with the single-frequency laser signal, eᵣ (x, y) represents an optical field amplitude of the single-frequency laser signal, eₛ(x, y, t) represents an optical field amplitude of the first signal to be measured, φₛ(x, y, t) represents a phase of the first signal to be measured, Δk represents a difference between the propagation constants of the ultrafast light field and the single-frequency laser signal, Aᵢₙ(x, y, t) represents a signal obtained after the first signal to be measured is beam combined with the single-frequency laser signal, i represents an imaginary unit, t represents a time variable, and x and y respectively represent a horizontal coordinate and a vertical coordinate in space. Based on a space-time correspondence principle, input-end dispersion (first dispersion), pump-end dispersion, and output-end dispersion (second dispersion) in the space-time synchronous amplification module can be M-times magnified in time-domain under a condition of satisfying an imaging relationship. The light field Aₒᵤₜ(x, y, t) output by the space-time synchronous amplification module is shown in the following expression:

$${A}_{out} ( x , y , t ) = {ℱ}^{- 1} ( ℱ \{ {ℱ}^{- 1} [ {A}_{i n} ( x , y , ω ) {\underbrace{exp ( {iD}_{i n} {ω}^{2} / 2 )}}_{input end dispersion} ] {\underbrace{ℱ [ exp ( {iD}_{f} {ω}^{2} / 2 ) ]}}_{pump end dispersion} \} {\underbrace{exp ( {iD}_{out} {ω}^{2} / 2 )}}_{output end dispersion} ) ∝ exp ( - i \frac{{t}^{2}}{2 {D}_{out} + {D}_{f}} ) {A}_{i n} ( x , y , \frac{{D}_{f} t / 2}{{D}_{out} + {D}_{f} / 2} ) ∝ {A}_{i n} ( x , y , \frac{t}{M} ) .$$

Aᵢₙ(x, y, ω) represents an expression in time domain of a signal obtained after the first signal to be measured and the single-frequency laser signal are beam combined, Aᵢₙ(x, y, ω) represents an expression in frequency domain of a signal obtained after the first signal to be measured and the single-frequency laser signal are beam combined, Aₒᵤₜ(x, y, t) represents the output signal obtained after the amplification in the time domain, Dᵢₙ and Dₒᵤₜ respectively represent a dispersion amount of the input end and a dispersion amount of the output end of the space-time synchronous amplification module, D_{f} represents the modulation parameter used in the process of the first periodic secondary phase modulation, M is the amplification factor, the symbol “ [symbol] ” represents Fourier transformation., the symbol “ [symbol] ⁻¹” represents inverse Fourier transformation, i represents imaginary unit, t represents a time variable, and to represents a frequency variable. The input ultrafast light field signal (the first signal to be measured) is amplified in time domain. Meanwhile, the input ultrafast light field signal can be deduced backwards from the coherent light field signal obtained by the first signal to be measured beam combined with the single-frequency laser signal by using the Fourier domain filtering method. Since a long time scale light field signal will overlap after undergoing time-domain amplification, the present invention proposes to use a spectral spectroscopy method to decouple the time-domain overlapping signal at the output end. A decoupled intensity signal A(x, y, τ; ω₀) obtained by passing the light field signal having passed through the space-time synchronous amplification module through a first spectral spectroscopic component is shown as in the following expression:

$$A ( x , y , n ; {ω}_{0} ) = {ℱ}^{- 1} [ ℱ [ {A}_{out} ( x , y , t ) ] {\underbrace{H ( ω - {ω}_{0} )}}_{frequency response} ] ∝ {A}_{i n} ( x , y , - {ω}_{0} {D}_{f} / 2 ) .$$

H(ω−ω₀) is a spectrum response function, ω₀ is a center frequency, and the symbol “∝” represents being proportional to Aₒᵤₜ(x, y, t) represents the output signal after having being time-domain amplified, and A(x, y, t; ω₀) represents the output signal obtained after passing the time-domain amplified signal through the first spectral spectroscopic component. The spectral spectroscopic components can act on the respective spatial positions, and then a multi-channel high-speed photoelectric conversion component is provided after each of the spectral spectroscopic components to convert the output signals into electrical signals, and the electrical signals are collected and recorded to obtain the time-domain information at the positions of the respective spatial points in the first signal to be measured.

In an embodiment, the third signal to be measured may enter into the time--domain stretching dispersion component, and after being time stretched, the ultrafast light field to be measured (the third signal to be measured) achieves time-frequency Fourier transformation.

Based on the principle of space-time correspondence, the strength I_{TSS}(x, y, t) of the output signal under the approximate condition of Fraunhofer diffraction can be expressed as:

$${I}_{TSS} ( x , y , t ) = {\vert \int {A}_{p} ( x , y , ω ) {e}^{- i {Φ}_{TS} {ω}^{2} / 2} {e}^{i ω t} d ω \vert}^{2} = {\vert \int {A}_{p} ( x , y , ω ) {e}^{( - i {Φ}_{TS} / 2 ) {( ω - t / {Φ}_{TS} )}^{2}} d ω \vert}^{2} {\to }^{Fraunhofer approximation} {\vert {A}_{p} ( x , y , \frac{t}{{Φ}_{TS}} ) \vert}^{2} .$$

Aₚ(x, y, ω) represents an expression in frequency domain of the light field of the pulse light portions of the third signal to be measured, Φ_{TS} represents a value of the dispersion amount of the time-domain stretching dispersion component, i represents an imaginary unit, t represents a time variable, and co represents a frequency variable.

In the frequency-domain measurement with high spectral resolution, a problem of overlapping in time-domain signal will occur after the time stretching time-frequency transformation. To solve the above problem, a spectral spectroscopy method can be used to decouple the time-domain overlapping signal at the output end. A decoupled intensity signal obtained by passing the time-domain light field output by the time-domain stretching dispersion component through a second spectral spectroscopic component is shown as in the following expression:

$${I}_{TSS} ( x , y , t ) = {\vert \int {A}_{p} ( x , y , ω ) {\underbrace{H ( ω - {ω}_{0} )}}_{spectrum response} {e}^{- i {Φ}_{TS} {ω}^{2} / 2} {e}^{i ω t} d ω \vert}^{2} {\to }^{approximate integration} {\vert {A}_{p} ( x , y , \frac{t}{{Φ}_{TS}} ) H ( \frac{t}{{Φ}_{TS}} - {ω}_{0} ) \vert}^{2} .$$

H(ω−ω₀) is a spectrum response function, ω₀ is a center frequency. It can be seen from the above expression that the time variable t and the frequency variable ω have a one-to-one correspondence relationship. The light field signal obtained after the time-domain stretching time-frequency transformation interacts with the spectral spectroscopic component and is then directly mapped to the time-domain signal at the time t=ω0Φ_{TS}. The spectral spectroscopic components perform spectral spectroscopy operation on each of the respective points in the space, and then a multi-channel high-speed photoelectric conversion component is provided after each of the spectral spectroscopic components to photoelectrically convert and collect the output signal to obtain the second frequency-domain information.

In an embodiment, the above time lens time-frequency transformation optical path includes a third dispersion component (an input end dispersion component), a second pump pulse light source, a second pump end dispersion component, a second highly nonlinear medium, a second optical filter, and a fourth dispersion component (a output end dispersion component).

The third dispersion component applies dispersion to the second signal to be measured to form second detection light; the second pump pulse light source generates an ultrashort pulse sequence as a second pump pulse; the second pump end dispersion component applies dispersion to the second pump pulse to form a second pump light; the second highly nonlinear medium provides an nonlinear medium for an nonlinear parametric process between the second detection light and the second pump light; the second optical filter filters out second idle-frequency light generated in the nonlinear parametric process; and the fourth dispersion component compresses the second idle-frequency light to obtain a signal after being time lens time-frequency transformation processed in time domain (initial frequency-domain information).

Specifically, the object distance Φᵢₙ, focal distance Φ_{f}, and image distance Φₒᵤₜ of the time lens time-frequency transformation optical path satisfy the following relationship: Φᵢₙ=Φₒᵤₜ=Φ_{f}.

As an embodiment, the above synchronous reference pulse source is a picosecond or femtosecond pulse laser, so that the generated synchronous reference pulse signals can carry accurate alignment marks, so that the first frequency-domain information and the second frequency-domain information can be aligned accurately.

As an embodiment, the pulse repetition frequency of the above synchronous reference pulse source is lower than the pulse repetition frequency of the pulse light source in the time lens time-frequency transformation optical path. In this way, the synchronous reference pulse signals respectively included in the first signal to be measured, the second signal to be measured, and the third signal to be measured will not interfere with the process of acquiring the time-domain information, the first frequency-domain information and the second frequency-domain information, and the accuracy in the process of acquiring the time--domain information, the first frequency-domain information, and the second frequency-domain information can be guaranteed.

In an example, the second signal to be measured enters the high refresh rate time lens time-frequency transformation optical path, and the frequency domain measurement process of the continuous light components of the ultrafast light field can be compared to the Fourier transform process in the spatial lens 2-f system, and the image E_{TL}(x, y, t) of the continuous light components in the light field after the time lens can be expressed as:

$${E}_{TL} ( x , y , t ) ∝ \{ rect ( \frac{t}{T} ) {A}_{cw} ( x , y , t ) exp [ i ( 2 {ω}_{p} - {ω}_{s} ) t ] {\underbrace{exp ( \frac{- {it}^{2}}{2 {Φ}_{f}} )}}_{second phase modulation} \} .$$

In the expression, the rectangular function

$$rect ( \frac{t}{T} )$$

describes the time-domain pulse as an equivalent lens, ωₚ represents a pump frequency, ωₛ represents a signal light frequency, Φ_{f} represents a modulation parameter used in the process of the second periodic secondary phase modulation in the time lens optical path, the symbol “∝” represents being proportional to, i represents an imaginary unit, A_{cw}(x, y, t) represents an expression of light field of the continuous light portions, E_{TL}(x, y, t) represents an image of the continuous light portion after the time lens, and t represents a time variable. After the fourth dispersion, the time-frequency Fourier transform is realized on the surface of the image, and the expression of the output light field E_{TLS}(x, y, t) is shown as follows:

$${E}_{TLS} ( x , y , t ) ∝ {ℱ}^{- 1} \{ ℱ [ {E}_{TL} ( x , y , t ) ] exp ( i {Φ}_{out} {ω}^{2} / 2 ) \} ∝ {\int }_{- ∞}^{+ ∞} \{ rect ( \frac{τ}{T} ) exp ( \frac{- i {τ}^{2}}{2 {Φ}_{f}} ) {A}_{cw} ( x , y , τ ) exp [ i ( 2 {ω}_{p} - {ω}_{s} ( x , y ) τ ) ] {\underbrace{exp [ - \frac{{i ( t - τ )}^{2}}{2 {Φ}_{out}} ]}}_{output dispersion , image surface} \} d τ ∝ exp ( \frac{- {it}^{2}}{2 {Φ}_{out}} ) sin c [ T ( δ ω ( x , y ) + \frac{t}{{Φ}_{out}} ) ] .$$

E_{TLS}(x,y,t) represents the expression of the light field output through the high refresh rate time lens optical path, Φₒᵤₜ represents the value of the dispersion amount (the dispersion amount of the fourth dispersion) at the output end in the time lens frequency-frequency transformation optical path, the symbol “ [symbol] ” represents the Fourier transformation, the symbol “ [symbol] ⁻¹” represents the inverse Fourier transformation; δω=2ωₚ−ωₛ, the variable δω of the function sinc carries information of the continuous light frequency ωₛ, and under the condition 2ΦₒᵤₜΔΩₚ<T_{R} in which ΔΩₚ represents the spectral bandwidth of the pump pulse in the time lens time-frequency transformation optical path and T_{R} represents the pulse interval time of the pump pulse, there will be no problem of overlapping of time-domain signal in the time stretching time-frequency transformation optical path. After the ultrafast light field have passed through the high refresh rate time lens time-frequency transformation optical path, a high-speed photoelectric conversion component is provided at each of the positions of the spatial points of the output signal to realize the collection and recording of the frequency-domain information of the continuous light portions of the signal, to obtain the first frequency-domain information.

In an embodiment, the above system for acquiring three-domain information of ultrafast light field further includes a single-frequency laser light source.

The above single-frequency laser light source generates a single-frequency laser signal, and the single-frequency laser signal is used to be beam combined with the first signal to be measured, so as to realize reconstruction of time-domain phase information and ensure the smoothness of the process of acquiring the time-domain information at the positions of the respective spatial points in the first signal to be measured.

In an embodiment, the above system for acquiring three-domain information of ultrafast light field further includes an analog-to-digital converter.

The analog-to-digital converter converts the information (such as time domain information, first frequency domain information, and second frequency domain information) to be input into the fusion terminal and output from the fusion terminal into corresponding digital information for back-end data processing.

In the above system for acquiring three--domain information of ultrafast light field, spatially resolved amplified time-domain light field signal is obtained through the space-time synchronous amplification module, and the overlapping in the signals is decoupled by the spectral spectroscopy and then a real-time measurement of the time-domain signal waveform at the respective spatial positions are achieved by the high-speed photoelectric conversion component. Meanwhile, the time-frequency Fourier transformation on the continuous light portions and the pulse light portions of the spatially complex light field time are completed respectively by using the time lens optical path and the time-domain stretching dispersion component, and the overlapping in the signals is decoupled by the spectral spectroscopy and then a real-time measurement of the high refresh rate frequency-domain information at the respective spatial positions are achieved with the high-speed photoelectric conversion components. The respective signals are synchronized and calibrated using the reference pulse source and the space-time-frequency three-domain information are fused by using the inversion algorithm, and finally achieves a real-time ultrafast measurement of space-time-frequency three-domain information of the ultrafast optical field with a high refresh rate (refresh rate greater than 1 GHz) and a high space-time-frequency resolution (time resolution up to approximately 50 fs, spatial resolution up to approximately 500 nm, and spectral resolution up to approximately 1 pm).

In an embodiment, a three-domain signal acquisition simulation is performed on the ultrafast light field signal with spatial complexity. The signal to be measured with spatial complexity is shown in FIG. 2. The light fields at different spatial positions are different in time domain. The simulation test results in time domain and in frequency domain for the signal to be measured Obtained through the system for acquiring three-domain information of the ultrafast light field provided by the present application are shown in FIG. 3 and FIG. 4, respectively. From these figures it can be seen that, the time-domain and frequency-domain information of the ultrafast light field at different spatial positions can be obtained by the system for acquiring three-domain information of the ultrafast light field of the present application.

In a specific example, a signal to be measured with a time length of 9 ns at a single spatial position is measured by the system for acquiring three-domain information of the ultrafast light field of the present application. The simulation result after passing through the measurement system of the present application is shown in FIG. 5, and it can be seen from this figure that the method for acquiring three-domain information of the ultrafast light field of the present application has the ability to distinguish the continuous light portions in the ultrafast light field, meanwhile, its measurement refresh rate reaches 1 GHz.

The technical features of the above-described exemplary embodiments can be combined arbitrarily. To simplify the description, riot all possible combinations of the technical features in the above embodiments are described. However, all of the combinations of these technical features should be considered as within the scope of this disclosure, as long as such combinations do not contradict with each other.

It should be noted that the term “first\second\third” involved in the embodiments of the present application is only to distinguish similar objects, and does not represent a specific order for these objects. It can be understood that, the specific order or sequential order of “first\second\third” can be exchanged where allowable. It should be understood that the objects distinguished by “first\second\third” may be interchanged where appropriate, so that the embodiments of the present application described herein can be implemented in an order other than those illustrated or described herein.

The terms “including” and “having” and any variations thereof in the embodiments of the present application are intended to cover non-exclusive inclusions. For example, a process, method, device, product, or equipment that includes a series of steps or modules is not limited to the listed steps or modules, but may optionally further include steps or modules that are not listed, or may optionally further include other steps or modules inherent to these process, method, product or equipment.

The “plurality” referred to herein refers to two or more. “and/or” is only an association relationship describing the associated object, which means that there can be three kinds of relationships, for example, A and/or B can mean three cases: A exists alone, A and B exist simultaneously and B exists alone. The character “/” generally indicates that the related objects before and after have an “or” relationship.

The above embodiments merely represent several embodiments of the present application, and the descriptions thereof are more specific and detailed, but they should not be construed as limitations to the scope of the present application. It should be noted that, for a person of ordinary skill in the art, several variations and improvements may be made without departing from the concept of the present application, and these are all within the protection scope of the present application. Therefore, the protection scope of the present application shall be subject to the appended claims.

1. A method for acquiring three-domain information of ultrafast light field, comprising:
acquiring time-domain information of positions of respective spatial points in a first signal to be measured;
acquiring first frequency-domain information of continuous light portions at positions of respective spatial points in a second signal to be measured;
acquiring second frequency-domain information of pulse light portions at positions of respective spatial points in a third signal to be measured; and
fusing the time-domain information, the first frequency-domain information and the second frequency-domain information, and determining three-domain information of an ultrafast light field signal according to information obtained by the fusion; wherein, the first signal to be measured, the second signal to be measured and the third signal to be measured are three signals obtained by splitting the ultrafast light field signal to be measured.

2. The method of claim 1, wherein before the acquiring time-domain information of positions of respective spatial points in a first signal to be measured, the method further comprises:
performing optical splitting processing after beam combining the ultrafast light field signal and a synchronous reference pulse signal, to obtain the first signal to be measured, the second signal to be measured, and the third signal to be measured;
after the acquiring the second frequency-domain information of the pulse light portions at the positions of the respective spatial points in the third signal to be measured, the method further comprises:
aligning any two of the time-domain information, the first frequency-domain information and the second frequency-domain information with a rest one thereof respectively according to synchronous reference pulse signals respectively included in the time-domain information, the first frequency-domain information and the second frequency-domain information; and
fusing the time-domain information, the first frequency-domain information and the second frequency-domain information after the time-domain information, the first frequency-domain information and the second frequency-domain information are aligned.

3. The method according to claim 1, wherein the acquiring the time-domain information at the positions of the respective spatial points in the first signal to be measured comprises:
performing time-domain amplification on the first signal to be measured to obtain a time-domain amplified signal;
performing spectral spectroscopy at positions of respective spatial points of the time-domain amplified signal; and
converting a plurality of signals obtained after the spectral spectroscopy into electrical signals to obtain the time-domain information at the positions of the respective spatial points.

4. The method according to claim 3, wherein the performing the time-domain amplification on the first signal to be measured to obtain the time-domain amplified signal comprises:
performing first dispersion processing on the first signal to be measured, applying first periodic secondary phase modulation in time domain to a light field signal obtained after the first dispersion processing, and performing second dispersion processing on the light field signal obtained after the modulation to obtain the time-domain amplified signal.

5. The method according to claim 4, wherein a dispersion parameter used in the first dispersion processing, a dispersion parameter used in the second dispersion processing, and a modulation parameter used in the process of the first periodic secondary phase modulation satisfy the following relationship:
$$\frac{1}{{D}_{i n}} + \frac{1}{{D}_{out}} = \frac{f}{{D}_{f}} ;$$
in the expression, Dᵢₙ represents the dispersion parameter used in the first dispersion processing, Dₒᵤₜ represents the dispersion parameter used in the second dispersion processing, and D_{f} represents the modulation parameter used in the process of the first periodic secondary phase modulation; and
a time-domain magnification M of the first signal to be measured is
$$M = \vert \frac{{D}_{out}}{{D}_{i n}} \vert .$$

6. The method according to claim 1, wherein the acquiring the first frequency-domain information of the continuous light portions at the positions of the respective spatial points in the second signal to be measured comprises:
performing time lens time-frequency transformation processing on the second signal to be measured, and converting optical signals at positions of respective spatial points in a signal obtained after the time lens time-frequency transformation processing into electrical signals to obtain the first frequency-domain information.

7. The method according to claim 6, wherein the performing the time lens time-frequency transformation processing on the second signal to be measured, and the converting the optical signals at the positions of the respective spatial points in the signal obtained after the time lens time-frequency transformation processing into the electrical signals to obtain the first frequency-domain information comprises:
performing third dispersion processing on the second signal to be measured to obtain a first dispersion signal;
applying second periodic secondary phase modulation in time domain to the first dispersion signal to achieve time lens processing to obtain a modulated signal;
performing fourth dispersion processing on the modulated signal to obtain initial frequency-domain information; and
performing photoelectric conversion on the initial frequency-domain information at the positions of the respective spatial points to obtain the second frequency-domain information.

8. The method according to claim 7, wherein a third dispersion amount and a fourth dispersion amount are respectively equal to a modulation parameter used in the process of the second periodic secondary phase modulation; and the third dispersion amount is a dispersion parameter used in the third dispersion processing; the fourth dispersion amount is a dispersion parameter used in the fourth dispersion processing.

9. The method according to claim 1, wherein the acquiring the second frequency-domain information of the pulse light portions at the positions of the respective spatial points in the third signal to be measured comprises:
performing dispersion and then performing Fourier transformation on the third signal to be measured to obtain a time-frequency transformed spectrum;
performing spectroscopy processing respectively on a light field signal at positions of respective spatial points in the time-frequency transformed spectrum to obtain a plurality of optical signals;
performing photoelectric conversion respectively on the respective optical signals to obtain the second frequency-domain information.

10. A system for acquiring three-domain information of ultrafast light field, comprising: a space-time synchronous amplification module, a first spectral spectroscopic component, a first multi-channel high-speed photoelectric conversion component, a time lens time-frequency transformation optical path, a second multi-channel high-speed photoelectric conversion component, a time-domain stretching dispersion component, a second spectral spectroscopic component, a third multi-channel high-speed photoelectric conversion component, and a fusion terminal;
the space-time synchronous amplification module performing time-domain amplification on the first signal to be measured to obtain a time-domain amplified signal; the first spectral spectroscopic component performing spectral spectroscopy at positions of respective spatial points of the time-domain amplified signal; the first multi-channel high-speed photoelectric conversion component converting a plurality of signals obtained after the spectral spectroscopy into electrical signals to obtain time-domain information at the positions of the respective spatial points; the first signal to be measured, the second signal to be measured and the third signal to be measured being three signals obtained by splitting a ultrafast light field signal to be measured;
the time lens time-frequency transformation optical path performing time lens time-frequency transformation processing on the second signal to be measured; the second multi-channel high-speed photoelectric conversion component converting optical signals at positions of respective spatial points in a signal obtained after the time lens time-frequency transformation processing into electrical signals to obtain first frequency-domain information;
the time-domain stretching dispersion component performing time-domain stretching on the third signal to be measured to realize Fourier transformation to obtain a time-frequency transformed spectrum; the second spectral spectroscopic component performing spectral spectroscopy on the time-frequency transformed spectrum to obtain decoupled time-domain overlapping information; the third multi-channel high-speed photoelectric conversion component performing photoelectric conversion on the decoupled time-domain overlapping information to obtain second frequency-domain information; and
the fusion terminal fusing the time-domain information, the first frequency-domain information and the second frequency-domain information to determine three-domain information of the ultrafast light field signal.

11. The system according to claim 10, further comprising a synchronous reference pulse source and an optical splitting component;
the synchronous reference pulse source generating a synchronous reference pulse signal; the optical splitting component splitting beam-combined ultrafast light field signal and synchronous reference pulse signal into the first signal to be measured, the second signal to be measured, and the third signal to be measured; and
the fusion terminal reading synchronous reference pulse signals included in the time-domain information, the first frequency-domain information and the second frequency-domain information respectively, aligning any two of the time-domain information, the first frequency-domain information, and the second frequency-domain information with a rest one thereof respectively, and fusing the time-domain information, the first frequency-domain information and the second frequency-domain information after the time-domain information, the first frequency-domain information, and the second frequency-domain information are aligned.

12. The system of claim 10, wherein the space-time synchronous amplification module comprises a first dispersion component, a first pump pulse light source, a first pump end dispersion component, a first highly nonlinear medium, a first optical filter and a second dispersion component;
the first dispersion component performing first dispersion processing on the first signal to be measured to form first detection light; the first pump puke light source generating an ultrashort pulse sequence as a first pump pulse; the first pump end dispersion component applying dispersion to the first pump pulse to form first pump light; the first highly nonlinear medium providing an nonlinear medium for a nonlinear parametric process between the first detection light and the first pump light; the first optical filter filtering out first idle-frequency light generated in the nonlinear parametric process; and the second dispersion component performing second dispersion processing on the first idle-frequency light to obtain the time-domain amplified signal.

13. The system of claim 10, wherein the time lens time-frequency transformation optical path comprises a third dispersion component, a second pump pulse light source, a second pump end dispersion component, a second highly nonlinear medium, a second optical filter, and a fourth dispersion component;
the third dispersion component applying dispersion to the second signal to be measured to form second detection light; the second pump pulse light source generating an ultrashort pulse sequence as a second pump pulse; the second pump end dispersion component applying dispersion to the second pump pulse to form second pump light; the second highly nonlinear medium providing an nonlinear medium for a nonlinear parametric process between the second detection light and the second pump light; the second optical filter filtering out second idle-frequency light generated in the nonlinear parametric process; and the fourth dispersion component compressing the second idle-frequency light to obtain a signal after being time lens time-frequency transformation processed in time domain.

14. The system according to claim 10, further comprising a single-frequency laser light source;
the single-frequency laser light source generating a single-frequency laser signal, and the single-frequency laser signal being used to be beam combined with the first signal to be measured to realize time-domain phase information reconstruction.
